(19) United States
(12) Patent Application Publication
(10) Pub. No.: US 2014/0081606 A1
(43) Pub. Date: Mar. 20, 2014

(54) SYSTEM AND METHOD FOR MODELING CORROSION-BASED MULTIPHASE FLOW FRICTION IN PIPES

(71) Applicants: MOHAMMED OMER, ANDHRA PRADESH (IN); SAMI ALNUAIM, DHAHRAN (SA)

(72) Inventors: MOHAMMED OMER, ANDHRA PRADESH (IN); SAMI ALNUAIM, DHAHRAN (SA)

(21) Appl. No.: 13/621,796

(22) Filed: Sep. 17, 2012

(51) Int. Cl. G06F 17/13

(52) U.S. Cl. 703/2

(57) ABSTRACT

The system and method for modeling corrosion-based multiphase flow friction in pipes is computer-implemented modeling software used to calculate the total pressure drop of a multiphase fluid flowing from an un-corroded portion of a pipe to a corroded portion of the pipe. In order to calculate the total pressure drop, gravitational deceleration, fluid deceleration, fluid friction and corrosion-based friction are each taken into account and included in the model. A conventional well, pipeline or the like is provided with a sensor, such as a fiber Bragg grating sensor or the like, for measuring an inner diameter of the pipe, and a sensor for measuring the coefficient of friction due to corrosion, such as an acoustic to resonant tensor cell tactile sensor or the like.

### BACKGROUND OF THE INVENTION

1. Field of the Invention

The present invention relates to computerized systems and methods for modeling multiphase flow in pipes, such as oil pipelines, and particularly to a system and method for modeling corrosion-based multiphase flow friction in pipes, and particularly to the calculation and modeling of pressure drop between an un-corroded portion of a pipe and a corroded portion thereof.

2. Description of the Related Art

Oil wells, pipelines and the like are subject to corrosion due to the passage of corrosive fluids, such as hydrogen sulfide, enhanced oil recovery chemicals and the like. Well flow capacity is typically modeled using conventional, idealized fluid dynamic equations, which are often integrated into commercially available software for such modeling. However, the conventional models do not take into account additional friction on the fluid flow within the pipe caused by the corrosion. However, in order to accurately model and predict the well flow capacity, this factor must be taken into account.

Thus, a system and method for modeling corrosion-based multiphase flow friction in pipes solving the aforementioned problems are desired.

### SUMMARY OF THE INVENTION

The system and method for modeling corrosion-based multiphase flow friction in pipes relates to the calculation and modeling of a pressure drop between an un-corroded portion of a pipe and a corroded portion thereof. In order to model the total pressure drop from the un-corroded portion of the pipe to the corroded portion of the pipe, dpₜₒₜₐₗ, a coefficient of friction μ_{corrosion} of an interior surface of the corroded portion of the pipe is first measured. The pipe has a total length of dl, the un-corroded portion has a length of dl₁, and the corroded portion has a length of dl₂, such that dl=dl₁+dl₂.

Any suitable type of fluid velocity measurement sensor (such sensors are well known in the art) may be used to measure the velocity v of a multiphase fluid flowing through the un-corroded portion of the pipe, and the velocity v_{c} of the multiphase fluid flowing through the corroded portion of the pipe. As the fluid flows from the un-corroded portion to the corroded portion, the fluid velocity decreases, and the change in fluid velocity dv is calculated as dv=v−v_{c}.

The inner diameters d and d_{corr} of the un-corroded portion of the pipe and the corroded portion of the pipe, respectively, are measured by any suitable type of sensor or measurement device, such as a fiber Bragg grating (FBG) sensor or the like. The total pressure drop from the un-corroded portion of the pipe to the corroded portion of the pipe dpₜₒₜₐₗ may then be calculated as:

$$\begin{matrix}{dp}_{total} = ( ( {ρ}_{tp} \times v \times dv ) / ( {g}_{c} \times dl ) ) dl + \\ ( g / {g}_{c} ) \times ( {ρ}_{tp} sin θ ) \times dl + \\ ( ( {f}_{tp} \times {ρ}_{tp} \times {v}_{m}^{2} ) / ( 2 {g}_{c} d ) ) \times {dl}_{1} + \\ ( ( {μ}_{corrosion} \times {ρ}_{tp} \times {v}_{cm}^{2} ) / ( 2 {g}_{c} {d}_{corr} ) ) \times {dl}_{2} ,\end{matrix}$$

where pₜₚ, is a total multiphase fluid density of the fluid flowing through the pipe, g is gravitational acceleration, g_{c} is a gravitational acceleration conversion factor, θ is an angle measuring angular displacement of an axis of the pipe with respect to horizontal, fₜₚ is a friction factor for laminar flow, vₘ is a mixture velocity density of the multiphase fluid flowing through the un-corroded portion of the pipe, and v_{cm} is a mixture velocity density of the multiphase fluid flowing through the corroded portion of the pipe. The result may then be displayed to the user on a conventional display or the like.

These and other features of the present invention will become readily apparent upon further review of the following specification and drawings.

### BRIEF DESCRIPTION OF THE DRAWINGS

FIG. 1 is a block diagram of a system for modeling corrosion-based multiphase flow friction in pipes according to the present invention.

FIG. 2 is a graph illustrating predicted bottom hole pressure as a function of fluid flow rate for a particular example modeled by a method for modeling corrosion-based multiphase flow friction in pipes according to the present invention, particularly illustrating the effect of a variable coefficient of friction due to corrosion.

FIG. 3 is a chart illustrating predicted pressure drop as a function of friction modeled for the example of FIG. 2 by the method for modeling corrosion-based multiphase flow friction in pipes according to the present invention.

FIG. 4 is a block diagram illustrating system components of a controller of the system for modeling corrosion-based multiphase flow friction in pipes according to the present invention.

Similar reference characters denote corresponding features consistently throughout the attached drawings.

### DETAILED DESCRIPTION OF THE PREFERRED EMBODIMENTS

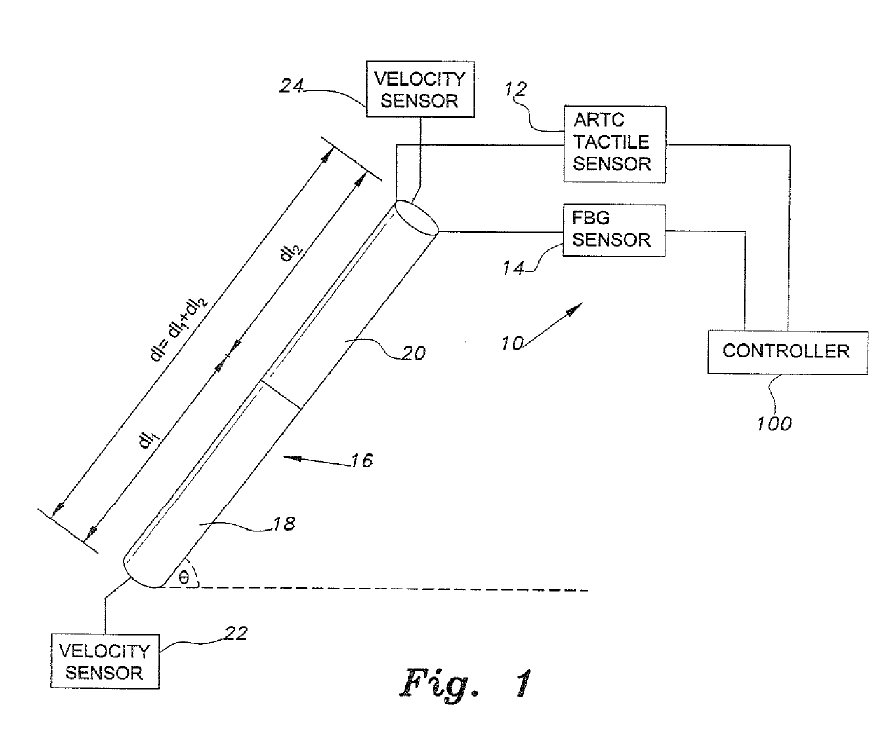

FIG. 1 illustrates an exemplary pipe 16 having an un-corroded portion 18 and a corroded portion 20. In order to model the total pressure drop dpₜₒₜₐₗ from the un-corroded portion 18 to the corroded portion 20, a coefficient of friction μ_{corrosion} of the interior surface of the corroded portion 20 of the pipe is first measured, The coefficient μ_{corrosion} may be measured by any suitable type of sensor or frictional measurement apparatus, such as an acoustic resonant tensor cell (ARTC) tactile sensor 12 or the like. The pipe 16 has a total length of dl, the un-corroded portion 18 has a length of dl₁, and the corroded portion 20 has a length of dl₂, such that dl=dl₁+dl₂.

Any suitable type of fluid velocity measurement sensor (such sensors are well known in the art) may be used to measure the velocity v of a multiphase fluid flowing through the un-corroded portion 18 of the pipe, and the velocity v_{c} of the multiphase fluid flowing through the corroded portion 20 of the pipe. FIG. 1 illustrates two such velocity sensors 22, 24 mounted on either end of the pipe 16, for measuring flow velocity v into the pipe and flow velocity v_{c} out of the pipe. As the fluid flows from the un-corroded portion 18 to the corroded portion 20, the fluid velocity decreases, and the change in fluid velocity dv is calculated as dv=v−v_{c}.

The inner diameters d and d_{corr} of the un-corroded portion 18 and the corroded portion 20, respectively, are measured by any suitable type of sensor or measurement device, such as a fiber Bragg grating (FBG) sensor 14 or the like. The total pressure drop from the un-corroded portion of the pipe to the corroded portion of the pipe dpₜₒₜₐₗ may then be calculated as:

$$\begin{matrix}{dp}_{total} = ( \frac{{ρ}_{tp} \times v \times dv}{{g}_{c} \times dl} ) \times dl + \frac{g}{{g}_{c}} \times ( {ρ}_{tp} sin θ ) \times dl + \\ ( \frac{{f}_{tp} \times {ρ}_{tp} \times {v}_{m}^{2}}{2 {g}_{c} d} ) \times {dl}_{1} + \\ ( \frac{{μ}_{corrosion} \times {ρ}_{tp} \times {v}_{cm}^{2}}{2 {g}_{c} {d}_{corr}} ) \times {dl}_{2} ,\end{matrix} \qquad ( 1 )$$

where pₜₚ is a total multiphase fluid density of the fluid flowing through the pipe 16, g is the gravitational acceleration constant near the surface (i.e., g=9.8 m/s²), g_{c} is a gravitational acceleration conversion factor, θ is an angle measuring angular displacement of an axis of the pipe 16 with respect to the horizontal, fₜₚ is a friction factor for laminar flow, vₘ is a mixture velocity density of the multiphase fluid flowing through the un-corroded portion 18 of the pipe 16, and v_{cm} is a mixture velocity density of the multiphase fluid flowing through the corroded portion 20 of the pipe 16.

In the above, the gravitational acceleration conversion factor g_{c} is simply a dimensional conversion factor, where g_{c}=1 kg·m/N·s². The variables vₘ and v_{cm} are mixture velocity densities. Keeping in mind that the fluid flowing through the pipe 16 is a multiphase fluid, the mixture velocity vₘ for uncorroded portion 18 is given by vₘ=(q_{L}+q_{G})/Aₚ, where q_{L}, is the liquid flow rate (volume per time), q_{G} is gas flow rate, and Aₚ is the cross-sectional area of the pipe in the uncorroded portion 18. Similarly, the mixture velocity v_{cm} for the corroded portion 20 is given by v_{cm}=q_{cL}+q_{cG}/A_{cp}, where q_{cL} is the liquid flow rate (volume per time), q_{cG} is gas flow rate, and A_{cp} is the cross-sectional area of the pipe in the corroded portion 20. The friction factor for laminar flow, fₜₚ, is, as is known in the field of fluid dynamics, determined analytically by combining the Darcy-Wiesbach equation with the Hagen-Poiseuille equation, such that fₜₚ=64/N_{RE}, where N_{RE} is the Reynold's number.

In order to derive equation (1), pressure drop in a pipe without considering corrosion is first considered. This pressure drop per unit pipe length is given by:

$$\frac{d p}{d l} = \frac{{ρ}_{tp} \times v \times dv}{{g}_{c} \times dl} + \frac{g}{{g}_{c}} \times {ρ}_{tp} sin θ + \frac{{f}_{tp} \times {ρ}_{tp} \times {v}_{m}^{2}}{2 {g}_{c} d} \qquad ( 2 )$$

where (pₜₚ×v×dv)/(g_{c}×dl) represents fluid acceleration, (g/g_{c})×pₜₚ sin θ represents gravitational acceleration, and (fₜₚ×pₜₚ×vₘ²)/(2g_{c}d) represents frictional deceleration.

Given a measured coefficient of friction μ_{corrosion} due to corrosion allows the addition:

$$\frac{d p}{d l} = \frac{{ρ}_{tp} \times v \times dv}{{g}_{c} \times dl} + \frac{g}{{g}_{c}} \times {ρ}_{tp} sin θ + \frac{{f}_{tp} \times {ρ}_{tp} \times {v}_{m}^{2}}{2 {g}_{c} d} + \frac{{μ}_{corrosion} \times {ρ}_{tp} \times {v}_{cm}^{2}}{2 {g}_{c} d} \qquad ( 3 )$$

Substitution of the lengths from dl=dl₁+dl₂ then gives:

$$\begin{matrix}dp = ( \frac{{ρ}_{tp} \times v \times dv}{{g}_{c} dl} ) \times dl + \frac{g}{{g}_{c}} \times ( {ρ}_{tp} sin θ ) \times dl + \\ ( \frac{{f}_{tp} \times {ρ}_{tp} \times {v}_{m}^{2}}{2 {g}_{c} d} ) \times {dl}_{1} + \\ ( \frac{{μ}_{corrosion} \times {ρ}_{tp} \times {v}_{cm}^{2}}{2 {g}_{c} {d}_{corr}} ) \times {dl}_{2} .\end{matrix} \qquad ( 4 )$$

Equation (4) represents the loss in pressure for a pipe corroded through some distance that would result in additional pressure drop due to corrosion. As corrosion also changes the diameter, the pipe wall thickness also decreases. The decrease in thickness c_{H} can be obtained from the FBG sensor 14. Thus, the new diameter becomes d_{corr}=d−c_{H}, or:

$${d}_{corr} = d - [ {b}_{o} - \frac{1}{2 E} ( \frac{pr}{\frac{{Δλ}_{H - comp}}{{λ}_{B} ( 1 - {p}_{e} )} - α ( {T}_{2} - {T}_{1} )} ) ( 1 - 2 ϑ ) ] , \qquad ( 5 )$$

where bₒ is the initial thickness of pipe 16, p is the operating pressure, r is the radius of the interior of the pipe, λ_{B} is the Bragg wavelength, Δλ_{H-comp} is the degree of shift in wavelength in the horizontal direction, E is the Young's modulus, T₁ and T₂ are the initial and final temperatures, respectively, measured before and after corrosion, θ is Poisson's ratio, p_{c} is the strain optic constant, and α is the thermal coefficient. Knowledge of d_{corr} then allows us to calculate dpₜₒₜₐₗ of equation (1).

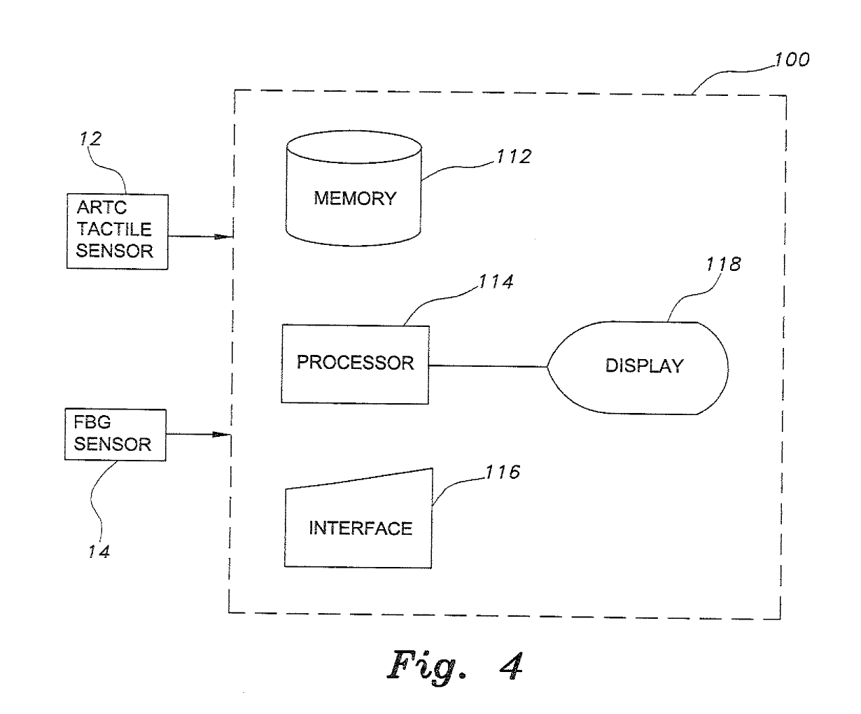

It should be understood that the calculations may be performed by any suitable controller 100, such as that diagrammatically shown in FIG. 4. Data is entered into controller 100 via any suitable type of user interface 116, and may be stored in memory 112, which may be any suitable type of computer readable and programmable memory and is preferably a non-transitory, computer readable storage medium. Calculations are performed by a processor 114, which may be any suitable type of computer processor and may be displayed to the user on display 118, which may be any suitable type of computer display.

The processor 114 may be associated with, or incorporated into, any suitable type of computing device, for example, a personal computer or a programmable logic controller. The display 118, the processor 114, the memory 112 and any associated computer readable recording media arc in communication with one another by any suitable type of data bus, as is well known in the art.

Examples of computer-readable recording media include a magnetic recording apparatus, an optical disk, a magneto-optical disk, and/or a semiconductor memory (for example, RAM, ROM, etc). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

In order to test the model represented by equation (1), an inflow performance curve (IPR) was modeled by the Darcy equation, an outflow performance curve (OPR) was modeled using the Mukherjee and Brill model, and the gas/oil ratio and the oil volume factor for a sample oil well were modeled using the Vasquez and Beggs model. For purposes of modeling, the following oil well/reservoir parameters were used: a well head temperature of 94° F., a flow line pressure of 100 psia, a flow line temperature of 60° F., a reservoir temperature of 170° F., a gas gravity of 0.6, a gas/oil ratio (GOR) of 600, an API gravity of 35, a flow line ID of 1.995 inches, a measured depth of 7,875 feet, and a roughness (with no corrosion) of 0.0018.

For a pipe of depth 7,875 feet, the non-corroded portion was chosen to have a length of dl₁=6,875 feet and the corroded portion was chosen to have a length of dl₂=1,000 feet. The friction factor for laminar flow fₜₚ was selected as 0.018, and a varying coefficient of friction due to corrosion was chosen with the values μ_{corrosion}=0.2, 0.3, 0.4.

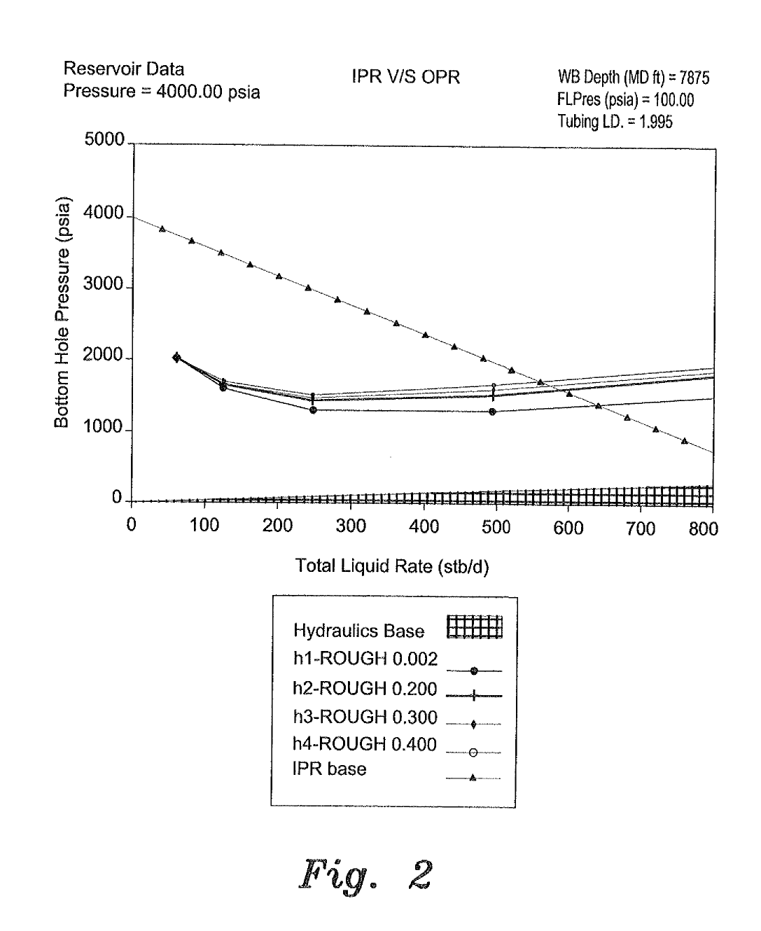

As shown in FIG. 2, the inflow and outflow performance relationship were plotted at the original roughness value of 0.0018. Then, the same model was run after varying the friction due to corrosion with values of 0.2, 0.3, and 0.4. The results of the initial and corroded cases are shown in FIG. 2 to show the effect of corrosion on the well performance.

In FIG. 2, the bottom-hole pressure was plotted versus the total liquid rate to assess the well performance of the initial no-corrosion ease and the other three corroded cases, along with the Inflow Performance Curve (IPR). The intersection of the IPR curve and the Outflow Performance Curves (OPR) of the four studied cases indicates the well flow capacity.

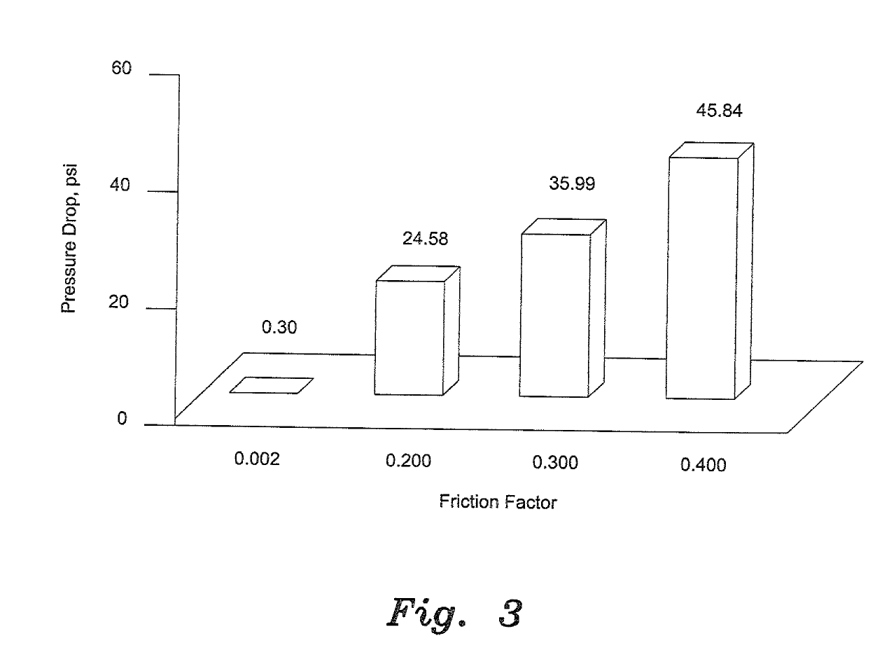

The plot indicates that the System Flow Capacity (Well Performance Indicator) with an initial roughness of 0.0018 (where no corrosion is considered) is 640, compared to values of 580, 572, and 555 STB/D, respectively, for the other three corroded cases (with coefficients of friction of 0.2, 0.3 and 0.4, respectively). The model of equation (1) indicated that when friction due to corrosion is not considered, an over-estimated value of the system flow capacity is obtained. Such an over-estimation can negatively influence decisions in relation to the well performance. When the effect of friction due to corrosion is considered, and using a variable friction factor, the system flow capacity can decrease 10-13% for this well model. The percentage can grow depending on the well model and the severity of the corrosion. The calculated pressure drop for the above four cases is plotted in FIG. 3.

FIG. 3 illustrates the friction factor on the horizontal axis, and its effect on the pressure drop on the vertical axis for the above four cases. The first bar represents the friction factor used in conventional modeling systems, which do not consider friction due to corrosion. As the model of equation (1) is incorporated, the pressure drop increases from 0.3 psi to 45.84 psi. This pressure drop due to corrosion has a large impact on the system flow capacity inside the well.

It is to be understood that the present invention is not limited to the embodiments described above, but encompasses any and all embodiments within the scope of the following claims.

We claim:

1. A system for modeling corrosion-based multiphase flow friction in pipes, comprising:
a processor;
computer readable memory coupled to the processor;
means for measuring a coefficient of friction μ_{corrosion} of an interior surface of a corroded portion of a pipe, wherein the pipe has a total length of dl, an un-corroded portion having a length of dl₁, and the corroded portion has a length of dl₂;
means for measuring a velocity v of a multiphase fluid flowing through the un-corroded portion of the pipe;
means for measuring a velocity v_{c} of the multiphase fluid flowing through the corroded portion of the pipe, wherein a change in fluid velocity dv is calculated as dv=v−v_{c};
means for measuring an inner diameter d of the un-corroded portion of the pipe;
means for measuring an inner diameter d_{corr} of the corroded portion of the pipe;
a display;
software stored in the computer readable memory and executable by the processor, the software having:
means for calculating a total pressure drop from the un-corroded portion of the pipe to the corroded portion of the pipe dpₜₒₜₐₗ as:
$$\begin{matrix}{dp}_{total} = ( ( {ρ}_{tp} \times v \times dv ) / ( {g}_{c} \times dl ) ) \times dl + \\ ( g / {g}_{c} ) \times ( {ρ}_{tp} sin θ ) \times dl + \\ ( ( {f}_{tp} \times {ρ}_{tp} \times {v}_{m}^{2} ) / ( 2 {g}_{c} d ) ) \times {dl}_{1} + \\ ( ( {μ}_{corrosion} \times {ρ}_{tp} \times {v}_{cm}^{2} ) / ( 2 {g}_{c} {d}_{corr} ) ) \times {dl}_{2} ,\end{matrix}$$
wherein pₜₚ is a total multiphase fluid density of the fluid flowing through the pipe, g is gravitational acceleration, g, is a gravitational acceleration conversion factor, θ is an angle measuring angular displacement of an axis of the pipe with respect to the horizontal, fₜₚ is a friction factor for laminar flow, vₘ is a mixture velocity density of the multiphase fluid flowing through the un-corroded portion of the pipe, and v_{cm} is a mixture velocity density of the multiphase fluid flowing through the corroded portion of the pipe; and
means for displaying the total pressure drop from the un-corroded portion of the pipe to the corroded portion of the pipe dpₜₒₜₐₗ to a user on the display.

2. The system for modeling corrosion-based multiphase flow friction in pipes as recited in claim 1, wherein the means for measuring inner diameters d and d_{corr} comprise fiber Bragg grating sensors.

3. The system for modeling corrosion-based multiphase flow friction in pipes as recited in claim 1, wherein the means for measuring the coefficient of friction μ_{corrosion} comprises an acoustic resonant tensor cell tactile sensor.

4. The system for modeling corrosion-based multiphase flow friction in pipes as recited in claim 3, wherein the means for measuring inner diameters d and d_{corr} comprise fiber Bragg grating sensors.

5. A method of modeling corrosion-based multiphase flow friction in pipes, comprising the steps of:
measuring a coefficient of friction μ_{corrosion} of an interior surface of a corroded portion of a pipe having has a length of dl₂, the pipe having a total length of dl and an un-corroded portion having a length of dl₁;
measuring a velocity v of a multiphase fluid flowing through the un-corroded portion of the pipe;
measuring a velocity v_{c} of the multiphase fluid flowing through the corroded portion of the pipe, wherein a change in fluid velocity dv is calculated as dv=v−v_{c};
measuring an inner diameter d of the un-corroded portion of the pipe;
measuring an inner diameter d_{corr} of the corroded portion of the pipe;
calculating a total pressure drop from the un-corroded portion of the pipe to the corroded portion of the pipe dpₜₒₜₐₗ as:
$$\begin{matrix}{dp}_{total} = ( ( {ρ}_{tp} \times v \times dv ) / ( {g}_{c} \times dl ) ) \times dl + \\ ( g / {g}_{c} ) \times ( {ρ}_{tp} sin θ ) \times dl + \\ ( ( {f}_{tp} \times {ρ}_{tp} \times {v}_{m}^{2} ) / ( 2 {g}_{c} d ) ) \times {dl}_{1} + \\ ( ( {μ}_{corrosion} \times {ρ}_{tp} \times {v}_{cm}^{2} ) / ( 2 {g}_{c} {d}_{corr} ) ) \times {dl}_{2} ,\end{matrix}$$
wherein pₜₚ is a total multiphase fluid density of the fluid flowing through the pipe, g is gravitational acceleration, g_{c} is a gravitational acceleration conversion factor, θ is an angle measuring angular displacement of an axis of the pipe with respect to the horizontal, fₜₚ is a friction factor for laminar flow, vₘ is a mixture velocity density of the multiphase fluid flowing through the un-corroded portion of the pipe, and v_{cm} is a mixture velocity density of the multiphase fluid flowing through the corroded portion of the pipe; and
displaying the total pressure drop from the un-corroded portion of the pipe to the corroded portion of the pipe dpₜₒₜₐₗ to a user on the display.

6. The method of modeling corrosion-based multiphase flow friction in pipes as recited in claim 5, wherein the inner diameters d and d_{corr} are measured by fiber Bragg grating sensors.

7. The method of modeling corrosion-based multiphase flow friction in pipes as recited in claim 5, wherein the coefficient of friction μ_{corrosion} is measured by an acoustic resonant tensor cell tactile sensor.

8. The method of modeling corrosion-based multiphase flow friction in pipes as recited in claim 7, wherein the inner diameters d and d_{corr} are measured by fiber Bragg grating sensors.
